(19) United States
(12) Patent Application Publication
(10) Pub. No.: US 2007/0296378 A1
(43) Pub. Date: Dec. 27, 2007

(54) Straddle-Type Vehicle

(75) Inventors: Yasuhiro OODACHI, Shizuoka (JP); Shigeto YAMASAKI, Shizuoka (JP)

Correspondence Address: HOGAN & HARTSON L.L.P., 1999 AVENUE OF THE STARS, SUITE 1400, LOS ANGELES, CA, 90067, US

(73) Assignees: YAMAHA HATSUDOKI KABUSHIKI KAISHA, Iwata-shi (JP); Yamaha Motor Co., Ltd.

(21) Appl. No.: 11/765,314

(22) Filed: Jun. 19, 2007

(30) Foreign Application Priority Data
Jun. 23, 2006 (JP) 2006-173917

(51) Int. Cl. H02H 7/06; H02P 9/00; H02P 11/00

(52) U.S. Cl. 322/28

(57) ABSTRACT

A straddle-type vehicle reliably cools a voltage regulator while inhibiting the voltage regulator from being negatively affected by water spray thrown up by a front wheel of the vehicle when it is running forward, or by flying objects that hit the vehicle from the front. The voltage regulator is attached to a front end side region of a rear arm.

### RELATED APPLICATIONS

This application claims the benefit of priority under 35 USC 119 of Japanese patent application no. 2006-173917, filed on Jun. 23, 2006, which application is hereby incorporated by reference in its entirety.

### BACKGROUND OF THE INVENTION

1. Field of the Invention

The present invention relates to a straddle-type vehicle like a motorcycle, and in particular relates to a straddle-type vehicle that is provided with a voltage regulator that regulates a voltage supplied to on-board electric components such as a battery.

2. Description of Related Art

In known straddle-type vehicles like a motorcycle, a voltage regulator (a rectifier regulator) is widely used. The voltage regulator rectifies the alternating current (power) generated by an alternator that is turned by driving force generated by an engine. In addition, the voltage regulator rectifies the voltage supplied to on-board electric components such as a battery. In order to convert excess electric power generated by the alternator to heat, the voltage regulator is often disposed in a position that is struck by running wind, for example, in the vicinity of a radiator attached to a down tube.

Straddle-type vehicles provided with a voltage regulator of this type are known in which, in order to improve external appearance and to provide protection against flying objects that hit the vehicle during running (like small stones), the voltage regulator is disposed inside of a swing-type power unit (for example, refer to JP-A-11-34965 (pages 5-7, FIG. 4)).

As described above, the voltage regulator is often disposed in the vicinity of the radiator, and more specifically, in the vicinity of the down tube. However, this position is liable to be hit by water spray thrown up by the front wheel of the vehicle itself or by the vehicle when it is running forward, which is undesirable.

In addition, the voltage regulator reaches a high temperature due to heat generation. Therefore, if the voltage regulator is disposed inside of an enclosed space such as inside the swing-type power unit, instead of being disposed in the vicinity of the radiator, it is not possible to adequately cool the voltage regulator. As a result, such positioning is undesirable since it has a negative impact on the efficiency and the service life of the voltage regulator.

### SUMMARY OF THE INVENTION

The invention has been devised in light of the above circumstances, and provides a straddle-type vehicle that reliably cools a voltage regulator while inhibiting the voltage regulator from being negatively affected by water spray thrown up by a front wheel of the vehicle itself or by the vehicle when it is running forward, or by flying objects that hit the vehicle from the front.

A first aspect of the invention is a straddle-type vehicle comprising a body frame, a wheel that rolls along a road surface, an arm member that supports the wheel and that is turnably supported by the body frame, and a voltage regulator that regulates a voltage supplied to an on-board electric component. The arm member includes a pivot member that is turnably supported by a pivot bearing formed in the body frame, the pivot member being formed in a front end side region of the arm member, and a wheel support member that rotatably supports the wheel and that is formed in a rear end side region of the arm member. The voltage regulator is attached to the arm member in the front end side region.

According to this structure, the voltage regulator is attached to the front end side region of the arm member. As a result, the extent to which the voltage regulator is hit by water spray thrown up by a front wheel of the vehicle itself or the vehicle running forward is reduced. In addition, the frequency with which flying objects (like small stones) hit the voltage regulator from the front during running is also reduced.

In addition, the voltage regulator is not provided in an enclosed space, but is simply attached to the arm member. As a result, running wind adequately cools the voltage regulator. In particular, because the voltage regulator is attached to the arm member that has a large surface area due to having a long lateral dimension, heat generated by the voltage regulator is efficiently dissipated by the arm member.

Generally, it has been considered difficult to attach a voltage regulator that requires wiring to an arm member that is a moveable component. However, the inventors have discovered, through repeated painstaking research that challenged this conventional thinking, that the above-described problems can be solved by attaching the voltage regulator to the arm member.

According to a second aspect of the invention, the arm member is eccentrically positioned so as to incline toward an outer side in a vehicle width direction as the arm member extends from the pivot member toward the wheel support member, and the voltage regulator is attached to a vehicle width direction outer side of the arm member and to the front end side region.

A third aspect of the invention further includes a power unit that generates driving force for the straddle-type vehicle, and a drive pulley that is turned by the power unit and that causes the wheel to turn using an endless transmission belt, in which at the least a front end of the drive pulley is disposed further forward than a front end of the arm member.

According to a fourth aspect of the invention, a height from the road surface to a center of the pivot member and a height from the road surface to a center of the drive pulley are substantially the same.

A fifth aspect of the invention further includes a voltage regulator cover that covers, at the least, a section of the voltage regulator that is to the vehicle width direction outer side, in which the voltage regulator cover has an outside air induction member that inducts outside air.

A sixth aspect of the invention further includes an endless transmission belt cover that covers the endless transmission belt, in which the voltage regulator is disposed in an endless transmission belt region that is surrounded by the endless transmission belt when the straddle-type vehicle is viewed from a side thereof, and a space that inducts outside air is formed between the voltage regulator cover and the endless transmission belt cover.

A seventh aspect of the invention further includes wiring connected to the voltage regulator, in which the wiring is connected to the voltage regulator at the pivot member side thereof.

The invention provides a straddle-type vehicle that reliably cools a voltage regulator while inhibiting the voltage regulator from being negatively affected by water spray thrown up by a front wheel of the vehicle itself or by the vehicle when it is running forward, or by flying objects that hit the vehicle from the front.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a left side view of a motorcycle according to an embodiment of the invention.

FIG. 2 is an expanded left side view of a periphery of an arm member that includes a voltage regulator according to the embodiment of the invention.

FIG. 3 is a cross sectional view taken along line F3-F3 of FIG. 2.

FIG. 4 is a cross sectional view taken along line F4-F4 of FIG. 2.

FIG. 5 is an expanded side view of a section of the arm member.

FIG. 6 is a cross sectional view taken along line F6-F6 of FIG. 5

FIG. 7 is a perspective view of a voltage regulator unit according to the embodiment of the invention.

### DETAILED DESCRIPTION OF THE INVENTION

(Overview of a Straddle-Type Vehicle According to an Embodiment of the Invention)

An embodiment of the invention is now described with reference to the drawings. In the following drawings, structural members that are the same or similar are denoted with the same or similar reference numerals. Also, the figures are schematic, so the relative scale of dimensions and the like may be different from the real object. Specific dimensions and the like can be determined with reference to the following description. In addition, the various figures include sections in which the relationship and scale of respective dimensions etc. are different.

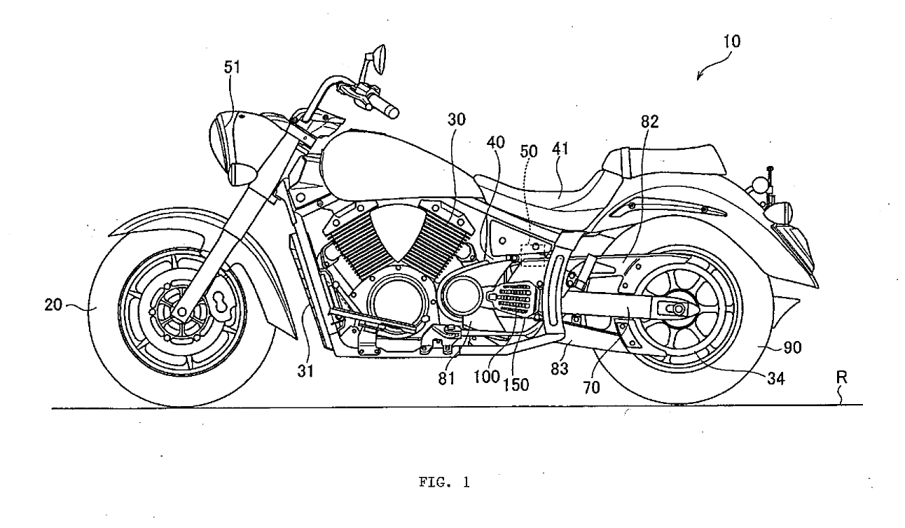

FIG. 1 is a left side view of a straddle-type vehicle according to the invention embodied as a motorcycle 10. Motorcycle 10 comprises a front wheel 20 and a rear wheel 90 (wheels) that roll over a road surface R.

Motorcycle 10 is an American cruiser motorcycle having a riding position where a rider extends both legs forward. An engine 30 (power unit) generates driving force that drives rear wheel 90. Engine 30 is a water-cooled, V-type 4-stroke engine, and is provided with a radiator 31.

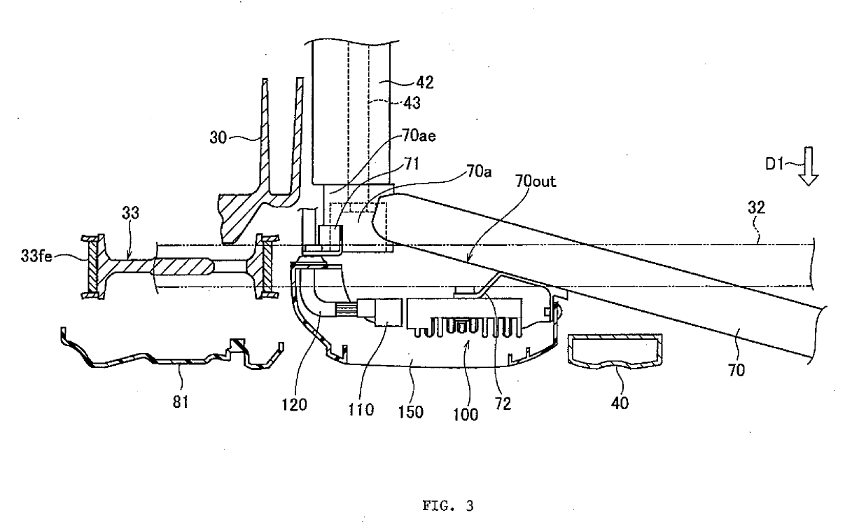

Motorcycle 10 uses a belt drive system. Engine 30 turns a drive pulley 33 (FIG. 3) that is coupled via a transmission (not shown). A cogged belt 32 (FIG. 3) is wrapped around drive pulley 33 and a driven pulley 34 that turns along with rear wheel 90. The driving force generated by engine 30 is thus transmitted to rear wheel 90.

Drive pulley 33 is covered by a pulley cover 81. In addition, cogged belt 32 is covered by an upper belt cover 82 and a lower belt cover 83. Upper and lower belt covers 82 and 83 form an endless transmission belt cover that covers cogged belt 32 (endless transmission belt).

Engine 30 and radiator 31 are attached to a body frame 40 of motorcycle 10. Body frame 40 also supports a seat 41 on which a rider sits. A battery 50 is housed in the space beneath seat 41.

A rear arm (arm member) 70 is supported by body frame 40 such that rear arm 70 is capable of turning. Rear arm 70 supports rear wheel 90. A rectifier regulator 100 is attached to rear arm 70.

Rectifier regulator (voltage regulator) 100 rectifies voltage supplied to on-board electric components such as battery 50, and a head light 51 connected via battery 50. More specifically, rectifier regulator 100 rectifies alternating current generated by an alternator (not shown) that is turned by engine 30. Rectifier regulator 100 is connected to battery 50 and rectifies voltage supplied to battery 50. Rectifier regulator 100 is covered by a regulator cover (voltage regulator cover) 150.

(Shape and Positioning Arrangement of the Rectifier Regulator)

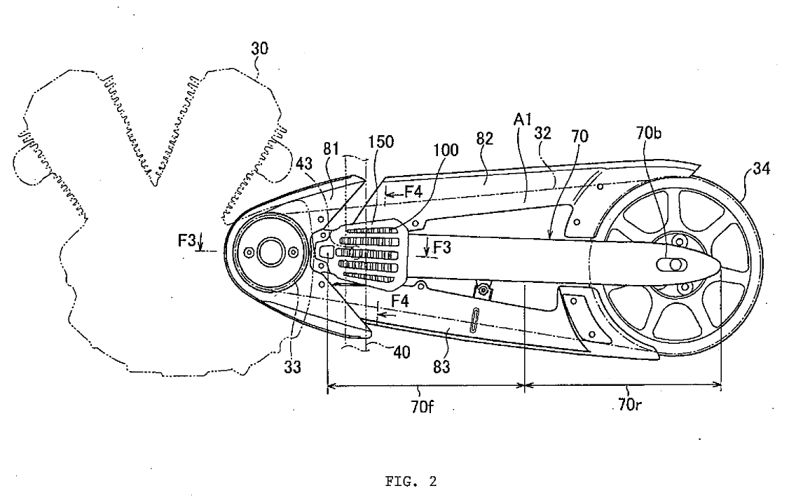

The shape and positioning arrangement of rectifier regulator 100 is now explained with reference to FIGS. 2-7.

(1) Shape of the Rectifier Regulator

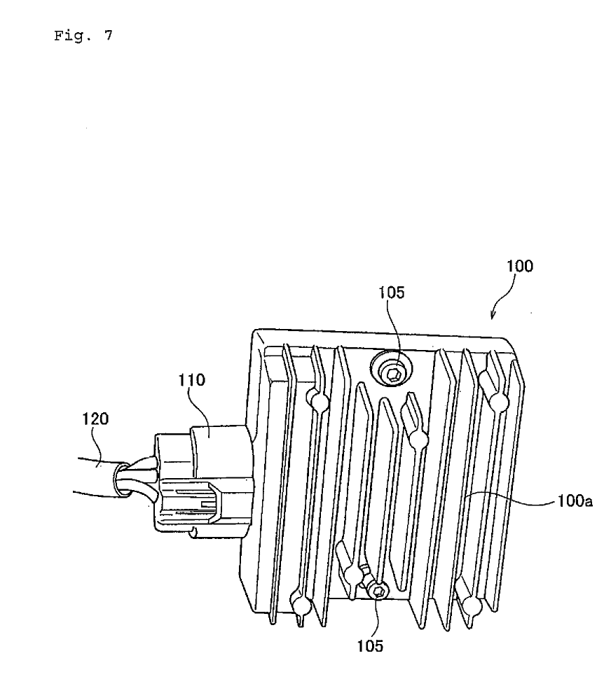

FIG. 7 is a perspective view of the rectifier regulator 100 unit. Rectifier regulator 100 converts excess electric power generated by the alternator (not shown) into heat. In order to do this, rectifier regulator 100 includes a plurality of cooling fins 100a that increase heat dissipation.

A regulator coupler 110 is connected to rectifier regulator 100. A harness 120 (cable) that connects to the alternator, battery 50 etc. is connected to regulator coupler 110.

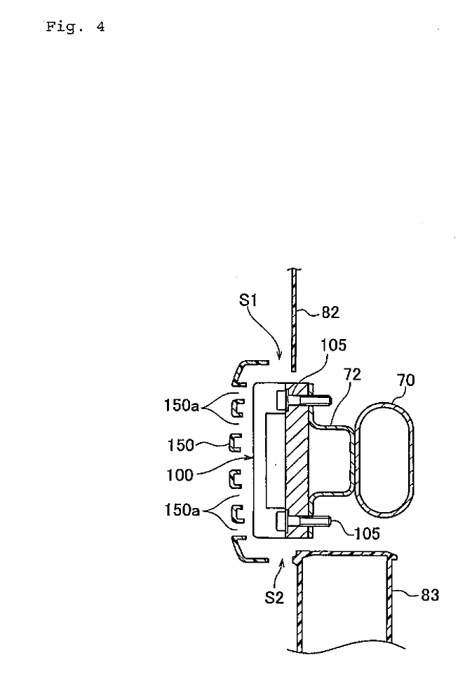

Rectifier regulator 100 is fixed to an arm plate 72 (FIGS. 3 and 4) provided on rear arm 70 using bolts 105 that are inserted through bolt holes (not shown) that are formed in the center of an upper section and the center of a lower section of rectifier regulator 100.

(2) Positioning Arrangement of the Rectifier Regulator

FIG. 2 is an expanded left side view of a periphery of rear arm 70 that includes rectifier regulator 100. FIG. 3 is a cross sectional view taken along line F3-F3 of FIG. 2. FIG. 4 is a cross sectional view taken along line F4-F4 of FIG. 2.

Rectifier regulator 100 is attached to rear arm 70. Referring to FIG. 3, rear arm 70 is turnably supported by a pivot bearing 42 formed in body frame 40, and has a pivot member 70a formed in a front end side region 70f of rear arm 70. A pivot shaft 43 is inserted through pivot member 70a and pivot bearing 42. The rear arm 70 is turnably supported by pivot shaft 43 inserted through pivot member 70a and pivot bearing 42.

Rear arm 70 rotatably supports rear wheel 90 and has a rear wheel support member 70b (a wheel support member) that is formed in a rear end side region 70r of rear arm 70.

Rectifier regulator 100 is attached to rear arm 70 in front end side region 70f. Front end side region 70f, as can be seen from FIG. 2, is the region to the front side of rear arm 70 when rear arm 70 is divided in half in the front-rear direction of motorcycle 10. Rear end side region 70r is the region to the rear side of the two halves.

Drive pulley 33, as described previously, is turned by engine 30 that is coupled to drive pulley 33 via the transmission (not shown). Cogged belt 32 is wrapped around drive pulley 33 and driven pulley 34, whereby driving force of engine 30 is transmitted to rear wheel 90.

Referring to FIG. 2, when motorcycle 10 is viewed from the side and a region that is surrounded by cogged belt 32 is taken to be a region A1 (endless transmission belt region), rectifier regulator 100 is disposed within region A1.

In addition, as can be seen in FIG. 3, rear arm 70 is eccentrically positioned so as to incline toward the outer side in the vehicle width direction (the side indicated by direction D1 of FIG. 3) as rear arm 70 extends from pivot member 70a toward rear wheel support member 70b. In front end side region 70f, rectifier regulator 100 is attached to the outer side in the vehicle width direction of rear arm 70, and more specifically is attached to an outer side surface 70 out and front end side region 70f (refer to FIG. 2). Rear arm 70 supports both the left and right sides of rear wheel 90 (more specifically, a wheel axle).

Rectifier regulator 100 is fixed to arm plate 72 provided on rear arm 70 using bolts 105 (FIG. 4). Regulator cover 150 is fixed to arm plate 72 and a cover stay 71 connected to pivot member 70a (FIG. 3).

Rectifier regulator 100 is covered by regulator cover 150 from the outer side in the vehicle width direction. Referring to FIG. 2 and FIG. 4, regulator cover 150 has slits 150a (outside air induction member) that induct outside air.

A space S1 that inducts outside air is formed between regulator cover 150 and upper belt cover 82 (FIG. 4). Similarly, a space S2 is also formed between regulator cover 150 and lower belt cover 83.

As shown in FIG. 3, not only is the section of rectifier regulator 100 to the outer side in the vehicle width direction covered by regulator cover 150, but sections of the rear and the front of rectifier regulator 100 are also covered by regulator cover 150. Moreover, as shown in FIG. 4, an upper side section of rectifier regulator 100 excluding space S1 and a lower side section of rectifier regulator 100 excluding space S2 are also covered by regulator cover 150.

Regulator coupler 110 is connected to rectifier regulator 100, and harness 120 is connected to regulator coupler 110 (FIG. 3). Harness 120 is connected to rectifier regulator 100 at the pivot member 70a side thereof. More specifically, regulator coupler 110 with the connected harness 120 is connected to a connection terminal (not shown) provided on a front surface side of rectifier regulator 100. Harness 120 connected to regulator coupler 110 is wired to extend toward the front, then bend toward pivot member 70a, and run toward the inner side in the vehicle width direction. Harness 120 connects to battery 50 fixed to body frame 40, the alternator (not shown) etc.

A front end 33fe of drive pulley 33 is disposed further to the front than a front end 70ae of rear arm 70. Not only is front end 33fe of drive pulley 33 disposed further to the front than pivot member 70a, but the entire drive pulley 33 is also disposed to the front of pivot member 70a of rear arm 70.

(3) Shape and Attachment State of the Arm Plate

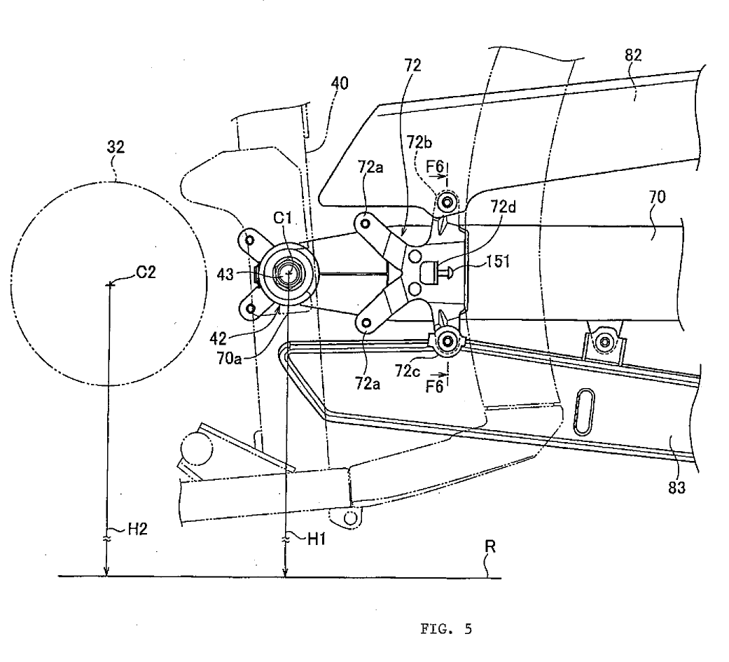

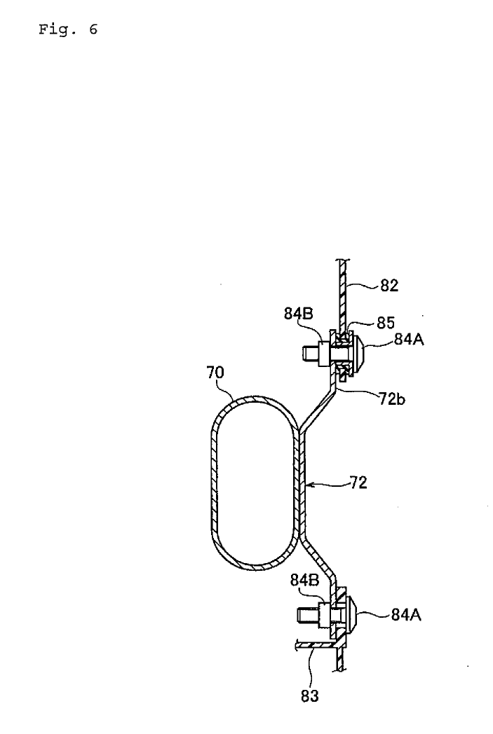

The shape of arm plate 72 to which rectifier regulator 100 is fixed and the attachment state thereof is now explained with reference to FIGS. 5 and 6. FIG. 5 is an expanded side view of a section of rear arm 70 including arm plate 72. FIG. 6 is a cross sectional view taken along line F6-F6 of FIG. 5.

Referring to FIG. 5, arm plate 72 includes a regulator attachment member 72a, an upper side belt cover support member 72b, a lower side belt cover support member 72c, and a regulator cover support member 72d.

Rectifier regulator 100 is attached to regulator attachment member 72a by bolts 105 (FIG. 4) that are inserted through bolt holes (not shown) provided in rectifier regulator 100.

Upper side belt cover support member 72b supports upper belt cover 82. As shown in FIG. 6, a bolt 84A and a grommet 85 are inserted in upper side belt cover support member 72b, and upper belt cover 82 is fixed to upper side belt cover support member 72b by bolt 84A and a nut 84B.

Lower side belt cover support member 72c supports lower belt cover 83. More specifically, another bolt 84A is inserted in lower side belt cover support member 72c, and lower belt cover 83 is fixed to lower side belt cover support member 72c by bolt 84A and another nut 84B.

Regulator cover support member 72d supports regulator cover 150. More specifically, a rivet 151 is inserted in regulator cover support member 72d, whereby regulator cover 150 is fixed to regulator cover support member 72d.

Arm plate 72 is welded to rear arm 70. Alternatively, arm plate 72 may be fixed to rear arm 70 using bolts or the like.

(4) Positional Arrangement of the Drive Pulley and the Rear Arm

The positional arrangement of drive pulley 33 and rear arm 70 is now explained with reference to FIG. 5. As described above, drive pulley 33 is disposed further to the front than rear arm 70.

A height H1 from road surface R to a center C1 of pivot member 70a and a height H2 from road surface R to a center C2 of drive pulley 33 are substantially the same. Rectifier regulator 100 that is fixed to arm plate 72 is disposed to the rear of drive pulley 33.

(Operation and Effects)

Rectifier regulator 100 is attached to front end side region 70f of rear arm 70. As a result, the extent to which rectifier regulator 100 is hit by water spray thrown up by front wheel 20 or the vehicle running forward is reduced. The frequency with which flying objects (like small stones) hit rectifier regulator 100 from the front during running is also reduced.

In addition, rectifier regulator 100 is not provided in an enclosed space, but is simply attached to rear arm 70. As a result, running wind adequately cools rectifier regulator 100. In particular, because rear arm 70 has a large surface area due to its long lateral dimension, heat generated by rectifier regulator 100 is efficiently dissipated by rear arm 70.

Furthermore, rear arm 70 is eccentrically positioned so as to incline toward the outer side in the vehicle width direction (the direction D1 side) as rear arm 70 extends from pivot member 70a toward rear wheel support member 70b. As described above, rectifier regulator 100 is attached to outer side surface 70 out and front end side region 70f in front end side region 70f.

More specifically, rear arm 70 is disposed further to the outer side in the vehicle width direction than pivot member 70a and further to the inner side in the vehicle width direction than rear wheel support member 70b. As a result, rectifier regulator 100 is disposed in “dead space” that does not interfere with other members and is not affected by steering of the rider. In addition, the vehicle width direction dimension of motorcycle 10 is not increased.

According to motorcycle 10, drive pulley 33 is disposed further to the front than front end 70ae of rear arm 70. In addition, height H1 from road surface R to center C1 of pivot member 70a and height H2 from road surface R to center C2 of drive pulley 33 are substantially the same. Because rectifier regulator 100 is fixed to front end side region 70f of rear arm 70, wind generated by rotation of drive pulley 33 (and cogged belt 32) is efficiently guided to flow to rectifier regulator 100.

According to motorcycle 10, rectifier regulator 100 is covered by regulator cover 150 that has slits 150a. Accordingly, cooling efficiency of rectifier regulator 100 is maintained while the extent to which water spray hits rectifier regulator 100 and the frequency with which flying stones hit rectifier regulator 100 from the front are reduced. In addition, regulator cover 150 uses the same design concept as the neighboring pulley cover 81, upper belt cover 82, and lower belt cover 83, and thus improves the external appearance of motorcycle 10.

Rectifier regulator 100 is disposed in region A1 surrounded by cogged belt 32. Space S1 that inducts outside air is formed between regulator cover 150 and upper belt cover 82. Similarly, space S2 is formed between regulator cover 150 and lower belt cover 83.

As a result, even thought upper belt cover 82, lower belt cover 83, and regulator cover 150 cover around the periphery of rectifier regulator 100, outside air is guided in via spaces S1 and S2 to reliably cool rectifier regulator 100.

Moreover, regulator coupler 110 and harness 120 are connected to rectifier regulator 100 at the pivot member 70a side thereof. More specifically, regulator coupler 110 with the connected harness 120 is connected to the connection terminal (not shown) provided on the front surface side of rectifier regulator 100. Harness 120 connected to regulator coupler 110 is wired to extend toward the front, then bend toward pivot member 70a, and run toward the inner side in the vehicle width direction. Harness 120 connects to battery 50 and the alternator (not shown).

As compared to a case where regulator coupler 110 and harness 120 are connected to a side surface side of rectifier regulator 100, the movement amount of regulator coupler 110 and harness 120 caused by swinging of rear arm 70 is reduced. As a result, the likelihood that connection problems of regulator coupler 110 or damage of harness 120 will occur is reduced.

(Other Embodiments)

One embodiment of the invention has been described. However, the invention is not limited by this description. From the disclosure, it will be apparent to those skilled in the art that the invention may have various modified forms.

For example, regulator coupler 110 and harness 120 do not always have to be connected to rectifier regulator 100 at the pivot member 70a side thereof. In addition, whether or not spaces S1, S2 and regulator cover 150 are provided may be determined based on the performance of rectifier regulator 100, the design of motorcycle 10 and the like.

In the above-described embodiment, the entire drive pulley 33 is provided to the front of rear arm 70. However, a structure may be adopted in which, at the least, front end 33fe of drive pulley 33 is disposed further to the front than rear arm 70 (front end 70ae). More specifically, the rear end of drive pulley 33 may be disposed further to the rear than rear arm 70 (front end 70ae). In addition, drive pulley 33 does not always have to be disposed to the front side of rear arm 70.

In the above-described embodiment, rear arm 70 is eccentrically positioned so as to incline toward the outer side in the vehicle width direction (the direction D1 side) as rear arm 70 extends from pivot member 70a toward rear wheel support member 70b. However, rear arm 70 need not be formed so as to widen to the outer side in the vehicle width direction as rear arm 70 extends from pivot member 70a toward rear wheel support member 70b.

The above-described embodiment includes rear arm 70. However, the invention is not so limited. So long as a swing-type arm is used, the invention may be applied to an arm member (front arm) that rotatably supports the front wheel. In addition, rear arm 70 has been described as supporting the wheel axle of rear wheel 90 from both the left and right sides. However, the invention may be applied to a structure in which an arm member supports the wheel axle of rear wheel 90 from just one side.

The above-described embodiment has been described with reference to an American cruiser motorcycle. However, the invention is not so limited, and may be applied to other types of motorcycles or straddle-type vehicles.

The invention includes various modified embodiments not specifically described here. The scope of the invention is defined by the following claims.

1. A straddle-type vehicle comprising:
a body frame;
a wheel that rolls along a road surface;
an arm member that supports the wheel and that is turnably supported by the body frame; and
a voltage regulator that regulates a voltage supplied to an on-board electric component, wherein
the arm member includes a pivot member that is turnably supported by a pivot bearing formed in the body frame, the pivot member being formed in a front end side region of the arm member, and a wheel support member that rotatably supports the wheel and that is formed in a rear end side region of the arm member, and
the voltage regulator is attached to the arm member in the front end side region.

2. The straddle-type vehicle according to claim 1, wherein the arm member is eccentrically positioned so as to incline toward an outer side in a vehicle width direction as the arm member extends from the pivot member toward the wheel support member, and the voltage regulator is attached to a vehicle width direction outer side of the arm member and to the front end side region.

3. The straddle-type vehicle according to claim 1, further comprising:
a power unit that generates driving force for the straddle-type vehicle; and
a drive pulley that is turned by the power unit and that causes the wheel to turn using an endless transmission belt, wherein
at least a front end of the drive pulley is disposed further forward than a front end of the arm member.

4. The straddle-type vehicle according to claim 3, wherein the entire drive pulley is disposed to the front of the pivot member of the arm member.

5. The straddle-type vehicle according to claim 3, wherein a height from the road surface to a center of the pivot member and a height from the road surface to a center of the drive pulley are substantially the same.

6. The straddle-type vehicle according to claim 2, further comprising:
a voltage regulator cover that covers a section of the voltage regulator that is to the outer side in the vehicle width direction, wherein
the voltage regulator cover has an outside air induction member that inducts outside air.

7. The straddle-type vehicle according to claim 6, wherein the outside air induction member comprises slits formed in the voltage regulator cover.

8. The straddle-type vehicle according to claim 6, further comprising:
an endless transmission belt cover that covers the endless transmission belt, wherein
the voltage regulator is disposed in an endless transmission belt region that is surrounded by the endless transmission belt when the straddle-type vehicle is viewed from a side thereof, and
a space that inducts outside air is formed between the voltage regulator cover and the endless transmission belt cover.

9. The straddle-type vehicle according to claim 8, wherein
the endless transmission belt cover comprises an upper belt cover and a lower belt cover, and
the space formed between the voltage regulator cover and the endless transmission comprises an upper space formed between the upper belt cover and the voltage regulator cover and a lower space formed between the lower belt cover and the voltage regulator cover.

10. The straddle-type vehicle according to claim 1, further comprising:
wiring connected to the voltage regulator, wherein
the wiring is connected to the voltage regulator at the pivot member side thereof.

11. The straddle-type vehicle according to claim 1, wherein the voltage regulator is not in an enclosed space and is cooled by running wind.

12. The straddle-type vehicle according to claim 1, wherein the arm member is a rear arm, and the wheel is a rear wheel.

13. The straddle-type vehicle according to claim 1, wherein the voltage regulator is fixed to an arm plate that is attached to the arm member.

14. The straddle-type vehicle according to claim 13, wherein the arm plate comprises:
a regulator attachment member;
an upper side belt cover support member;
a lower side belt cover support member; and
a regulator cover support member.

15. The straddle-type vehicle according to claim 1, wherein the straddle-type vehicle is a motorcycle.
